(19) United States
(12) Patent Application Publication
(10) Pub. No.: US 2003/0161453 A1
(43) Pub. Date: Aug. 28, 2003

(54) Flexible and scalable integrated access device

(76) Inventor: Robert A. Veschi, Wesley Chapel, FL (US)

Correspondence Address: SKADDEN, ARPS, SLATE, MEAGHER & FLOM LLP, ATTN: JAN STEELE, 525 UNIVERSITY AVENUE, SUITE 1100, PALO ALTO, CA, 94301, US

(21) Appl. No.: 10/366,470

(22) Filed: Feb. 14, 2003

Related U.S. Application Data
(60) Provisional application No. 60/359,483, filed on Feb. 25, 2002.

(51) Int. Cl. H04M 11/00

(52) U.S. Cl. 379/93.05; 379/93.01; 379/93.06; 379/93.07

(57) ABSTRACT

A method and apparatus for integraling data and telephony services is disclosed Specifically, the device dynamically configures network input and output ports of the device to support connectivity to a varying number of data networks, a varying number of public switched telephone networks, and a varying number of communication devices. The device also dynamnicly adopts broadband access technologies to access the data networks and maintains data interoperability among the data networks, the public switched telephone networks, and the communication devices.

### RELATED APPLICATIONS

This application claims the benefit of U.S. Provisional Application No. 60/359,483, filed Feb. 25, 2002.

### FIELD OF THE INVENTION

This application relates generally to telephony and data networks and, more specifically, to a device and method for integrating telephony and data services.

### BACKGROUND OF THE INVENTION

Historically, telephony services have been provided through a circuit-switched based network known as the Public Switched Telephone Network (PSTN) Providing telephony services is a time-consuming, resource intensive and costly process. Typically, anywhere from two weeks to a month of lead-lime is required to provide telephony services into a business or a new home. Even after initial services are provided, adding additional lines and features requires contacting the service provider again and may involve dispatching a service technician to the business or home.

Futhermore, in addition to telephony services, most businesses also require data services. To support both telephony and data, two separate networks are often deployed. In residential homes, the increase in equipment to support two separate networks may only be a modem [e.g., cable or Digital Subscriber Lines (DSL)] to support an additional data network (e.g., access to the Internet) However, for businesses, more equipment and space may be required to support two separate networks. For example, a telephone network for a business often requires not only the phones, themselves, but also a Private Branch Exclhange (PBX) in order to provide a private network that routes internal calls without the need to access the PSTN. Furthermore, a separate packet-switched data network (e.g., LAN) may require separate equipment such as servers, gateways, routers. switches, hubs, and firewalls. FIG. 1 illustrates an example of a business 100 with a separate telephone network and data network. In the business 100's telephone network, a plurality of phones (e.g., 112, 113, and 114), are connected to a PBX 115. The PBX 115 serves as the business 100's access point to the external world. That is, the PBX 115 connects the business 100 to the local service provider's central office 116, which provides access to the PSTN 118.

The business 100 also has a separate data network. A plurality of computers (e.g., 122, 123, and 124), are linked by an Ethernet hub 125 and are protected by a firewall server 126. External to the firewall server 126 is another Ethernet hub 128, which also links a plurality of computers (eg, 130 and 131), as well as a public Web server 132. Both hubs are connected to a router 134, which routes traffic to the appropriate hubs and serves as the access point to the Internet 136. As illustrated in FIG. 1, the need to maintain two networks, including, perhaps, paying two separate service providers (telephone and Interet) can become quite burdensome for the business.

Recently, Voice over IP (VoIP) technology has emerged as an alternative to the PSTN. VoIP technology enables a user to route telephone calls over an Internet Protocol (IP) network, rather than the PSTN, thereby reducing the cost of long distance calls. For example, in one implementation of VoIP, when a user a dials a long distance phone number, the call is routed (as a local call) through the local telephone company's network to a VoIP provider The VoIP provider then converts the digital (or analog) sequence of the call into data packets (eg., packetization) and routes the call over the Internet to the receiver's local calling area, where the VoIP provider completes the connection by converting the data packets back into a digital (or analog) sequence and then routing the call through the receiver's local telephone network. Such an implementation of VoIP circumvents the long distance portion of the PSTN and thereby eliminates long distance telephone charges. Those skilled in the art will recognize that the foregoing example is only one illustration of a variety of ways to exploit VoIP technology. For example and without limitation, VoIP can also be implemented over WAN or LAN environments other than the Internet. Furthermore, as illustrated in FIG. 2, the packetization of the voice signal need not necessarily occur at a VoIP provider. Such packetization could occur locally, for example and without limitation, (1) on an IP-enabled phone 210 that connects directly through an IP connection 212 to the IP network; (2) an IP converter device 220 connected directly to an individual phone through a regular phone connection 222 and to the IP network through an IP connection 224; (3) a line gateway device 230 connected to a plurality of phones through regular phone connections (e.g., 231 and 232), and to the IP network through an IP connection 234, thereby providing an IP interface for a plurality of phones and managing the incoming IP streams; or (4) an IP-enabled PBX 240 connected to a plurality of phones through regular phone connections 242 and to the IP network through an IP connection 244.

The ability to provide voice service through an IP network with VoIP technology enables a business to efficiently converge separate telephony and data networks into a single network. In particular, a small business can now employ devices generally known as Integrated Access Devices (IADs) to build a single data network that also supports telephony through VoIP technology. A good example of a lower-end IAD is the Cisco ATA 186 Analog Telephone Adaptor. The ATA 186 converts traditional phones into IP-enabled phones. The ATA 186 has two voice ports, referred to as Foreign Exchange Station (FXS) ports, to connect two telephones and an Ethernet port.

FIG. 3 illustrates an example of an IAD 310 similar to the ATA 186 as used in a small business 300. As illustrated, the IAD 310 has two FXS ports (eg., 312 and 313) that are connected to two phones (eg., 320 and 321) and an Ethernet port 314 connecting the IAD 310 to the rest of the IP network 330. The business 300 employs this single IP network 330 to accommodate both telephony and data services. The IAD 310 enables the business 300 to route internal phone calls through the IP network 330 to other phones (eg., 322 and 324) that are connected to an IAD 326, to computers 340 with voice capabilities (i.e., a “soft phone”), and directly to IP-enabled phones 350. The IAD 326 also enables the business 300 to route external calls through the Internet 360, through a voice gateway 370 that provides an interface between the Internet 360 and the PSTN 380, through the PSTN 380 and ultimately to a phone 390 that is connected to the PSTN 380.

In addition to Cisco's ATA 186, the TEKDigiTel V-Server iGate is a comparable IAD, having two voice ports, configurable as FXS or Foreign Exchange Office (FXO) ports, and two Ethernet ports, intended to be used for a WAN and LAN. The configurability of the voice port as an FXO port that can be connected to a PSTN line enables the V-Server iGate to serve as a voice gateway similar to the voice gateway 370 in FIG. 3. Similarly, the Mediatrix APA III-4FXS is an IAD that provides four FXS ports, an emergency bypass port used to connect to a standard PSTN line, and a single Ethernet port. Furthermore, expensive higher-end IADs that are designed primarily for service providers are also available. For example, Cisco IAD2400 Series IADs offer a choice of (1) 8 FXS ports, 16 FXS ports, 16 FXS ports and 8 FXO ports, or one T1 digital port for voice connectivity; (2) a T1 port or DSL port for broadband access; and (3) an Ethernet port for LAN capability.

Nevertheless, all the IADs described above have significant limitations. First, neither the lower nor higher-end IADS provide the capability to dynamically increase the number of FXS ports. They all have a static number of voice ports that cannot be increased. Furthermore, many of the IADs lack the flexibility to utilize these voice ports as either FXS or FXO ports, thereby eliminating the ability to convert the IAD into a voice gateway. Additionally, the above IADs only provide a single broadband option—for example, T1, DSL, cable, dial-up or wireless. That is, none of the IADs provides the flexibility to accommodate various types of broadband access technologies. Lastly, none of the above IADs supports on-demand resource allocation and management functionality In sum, currently available IADs are neither scalable nor flexible enough to accommodate the constantly developing and adapting needs of a business. As such, an affordable, scalable, and flexible IAD is needed.

### SUMMARY OF THE INVENTION

According to the present invention, an affordable, scalable, and flexible IAD provides the capabiity to dynamically increase the number of voice ports, to configure the voice ports as different types of ports, to accommodate a variety of broadband access technologies, to provide on demand resource allocation and management functionality, and to prioritize data delivery. Because its capabilities expand with a growing business, the need to obtain additional equipment to expand telephony and data capabilities is reduced, and costs for training, learning, and maintaining both telephony and data hardware and software are minimzed.

### BRIEF DESCRIPTION OF THE DRAWINGS

FIG. 1 illustrates a business maintaining a separate telephony network and data network (prior art).

FIG. 2 illustrates a variety of implementations of VoIP technology (prior art).

FIG. 3 illustrates an embodiment of an IAD used in a business to converge telephony and data capabilities (prior art).

FIG. 4 illustrates an exemplary embodent of a block diagram of an IAD.

FIG. 5 is a diagram of an exemplary embodiment of a telephony interface.

FIG. 6 is a block diawun of an IAD used in one business.

FIG. 7 is a block diagram of an IAD used in another business.

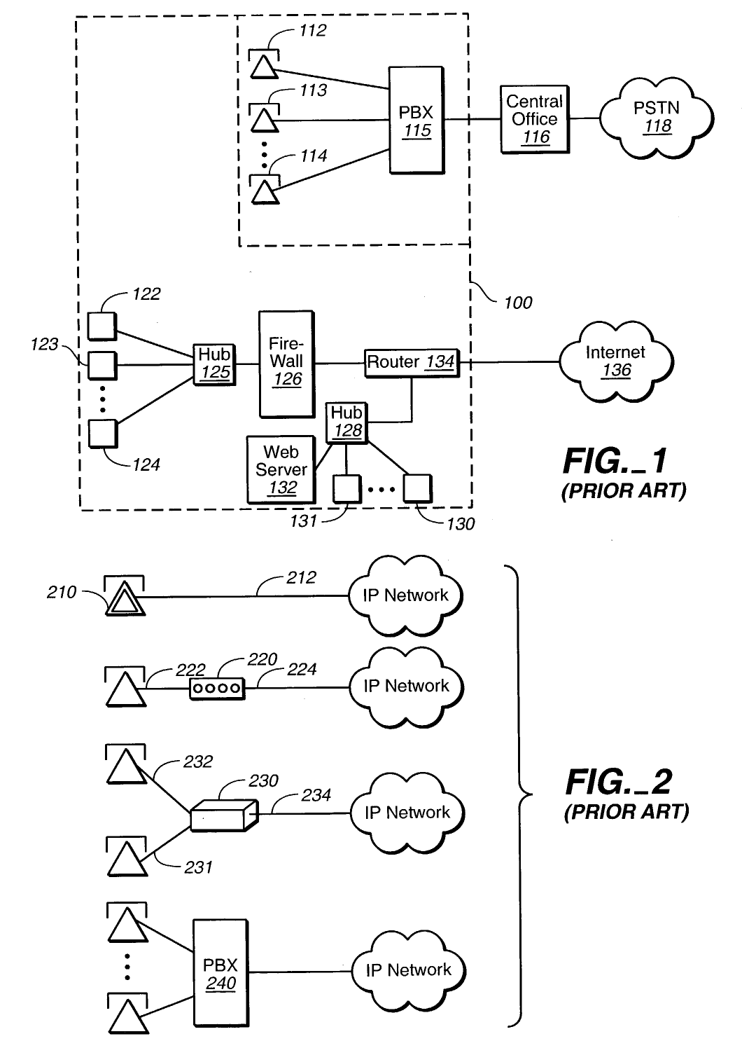

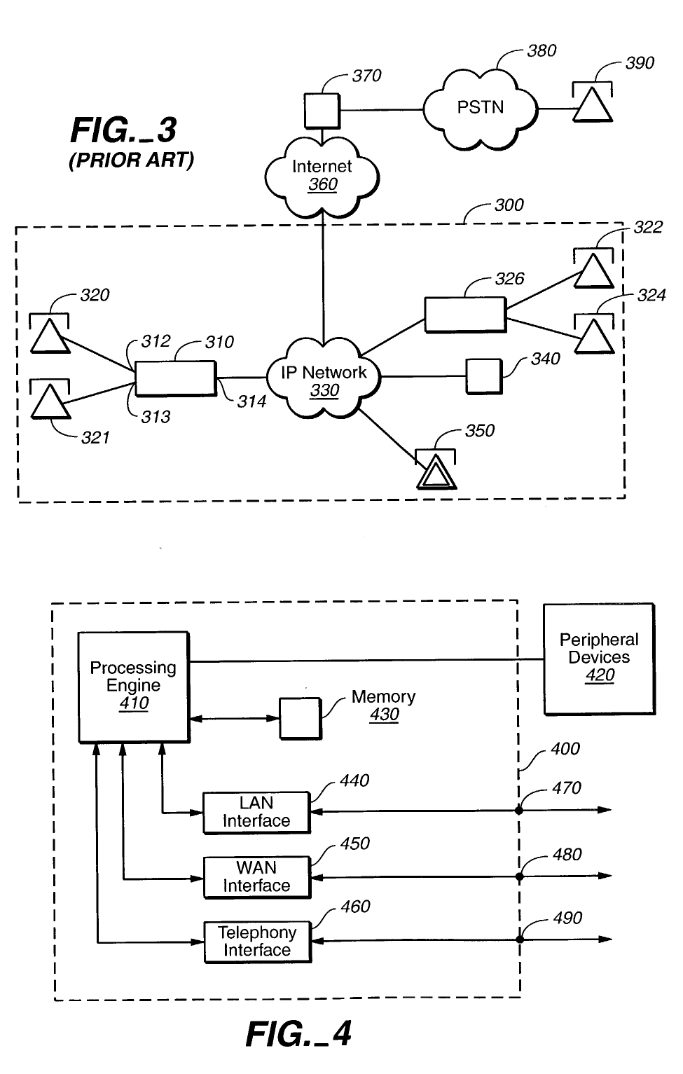

### DETAILED DESCRlIP1ON OF THE INVENTION

A method and apparatus for accommodating a variety of broadband access technologies is described. In the following description, numerous specific details are set forth in order to provide a thorough understanding of the present invention. However, it will be apparent to one of ordinary skill in the art that the invention may be practiced without these particular details. In other instances, well-known elements and theories such as, circular buffers, Internet Protocol (IP), Digital Subscriber Line (DSL), Voice over IP (VoIP), Session Initiation Protocol (SIP), Voice over DSL (VoDSL), Voice over ATM (VoATM), Voice over Frame Relay, Network Address Translation (NAT), Dynamic Host Configuration Protocol (DHCP), and Media Gateway Control Protocol (MGCP), have not been discussed in special details in order to avoid obscuring the present invention.

FIG. 4 illustrates one embodiment of block diagram of an IAD 400, which provides the capability to dynamically increase the number of voice ports, to configure the voice ports as either FXS or FXO ports, to accomnnodate a variety of broadband access technologies, and to prioritize data delivery. As shown, the processing engine 410 manages communications and functionality within the IAD 400. For example and without limitation, the processing engine 410 may include a microprocessor (i.e., CPU). Alternative embodiments may also include a DSP (Digital Signal Processr) The processing engine 410 manages the peripheral devices 420 including but not limited to external devices such as a monitor, mouse, or keyboard that may be used to configure parameters and functionality, as well as other internal or integrated peripherals. Similarly, the processing engine 410 also utilizes memory modules 430 possibly including but not limited to flash memory, RAM memory (e.g., DRAM, SDRAM, etc), hash memory, caches, IDE interfaces, firmware modules (eg. ROM), secondary memory, and other types of memory and memory interfaces. Although not explicitly shown in FIG. 4, a person having ordinary skill in the art will recognize that memory may also reside in the processing engine 410.

The processing engine 410 further manages a number of network input/output (I/O) ports, such as network I/O ports that connect to different types of networks. For example, the processing engine 410 may manage a LAN interface 440, a WAN interface 450 and a telephony interface 460 that connect to a LAN, a WAN, and a telephone network via network I/O ports 470, 480, and 490, respectively. For example and without limitation, one embodiment of the LAN interface 440 may be an Ethernet 10/100Base-T interface (eg., RJ-45 connector). Those skilled in the art will recognize that other LAN interfaces may also be used, including without limitation, token buses or token rings. It should also be emphasized that the IAD 400 is not limited to a fixed number of network I/O ports. The processing engine 410 is capable of supporting a varying number of network I/O ports. The subsequent Universal WAN Interface section will explain one process of adding or removing a network I/O port.

In addition, the processing engine 410, together with the WAN interface 450 and the telephony interface 460, support Plug and Play (PnP) functionality. This allows a user of the IAD 400 to modify the network access capabilities of the IAD without having to replace the IAD. For example, the user may require the use of a cable modem to access the Internet based changing circumstances (e.g., the monthly fee for cable is suddenly dramatically lower than xDSL). The user can remove an expansion board that allows the IAD 400 to access the Internet through xDSL and insert another expansion board that allows the InTernet access through cable lines. The subsequent Universal WAN Interface section will explain exemplary processes of modifying network access technologies.

The processing engine 410 also manages the data flow from one interface to another. One embodiment of the processing engine 410 mnaintains a set of addresses for the devices that are connected to a LAN that is attached to the LAN interface 440 and has the capabilities to generate network addresses that are recognizable on the WAN, such as the Internet, that is attached to the WAN interface 4501. As an illustration, suppose a device 1 and a device 2 are on a LAN X, which is attached to the LAN interface 440. The conununication between the two devices on the LAN X then involves the “local” addresses that the processing engine 410 maintains. On the other hand, suppose the device 1 sends a packet Z to a device 3 that is connected to a WAN Y, which is attached to the WAN interface 450, the processing engine 410 is then responsible for mapping the destination address of the packet Z to an address that is recognizable by WAN Y before sending the packet Z to the device 3. A person having ordinary skill in the art should recognize that various network address translation methods (NAT, also known as IP masquerading) can be used without exceeding the scope of the claimed invention.

Moreover, an exemplary embodiment of the processing engine 410 supports on-demand resource allocation and management. Using the aforementioned NAT functionality and the devices 1, 2, and 3 as an illustration, suppose the device 1 requests to receive a media stream from the device 3 on port 2345. In response to the service request, the processing engine 410 may allocate port 3456 and an recognizable WAN Y address, 1.111.11.111, for the device 3 to transmit the requested media stream to the device 1. The processing engine 410 is resportsible for mapping the address information and the port information in the data packets (representing the media stream) from the device 3 to the address of the device 1 and the port 2345. The processing engine 410 is also responsible for locating the device 3 and ensuring that the device 3 receives the service request from the device 1. After having completed the transmission, the processing engine 410 releases the allocated address, 1.111.11.111, and port 3456 and makes the resources available for subsequent service requests. It should be apparent to a person of ordinary skill in the art that this described on-demand resource allocation and management functionality also applies to “in-bound” requests (i.e, the device 3 requests to receive a media stream from the device 1).

As for the telephony data that the IAD 400 receives through telephony interface 460, if the telephony data are destined for another telephone that is attached to telephony interface 460, one embodiment of the telephony interface 460 directly routes the data to the destined telephone. However, if the telephony data are destined for a device that is either on a LAN that is attached to the LAN interface 440 or on a WAN that is attached to the WAN interface 450, similar to the discussion above, the processing engine 410 is responsible for performing the on-demand NAT.

The processing engine 410 also supports quality of service capabilities. Specifically, because the IAD 400 manages multiple network interfaces, the IAD 400 uses prioritization and a non-blocking architecture (discussed in the subsequent Non-blocking architecture section) to ensure timely delivery of data. Specifically, in an exemplary embodiment of the IAD 400, the processing engine 410 treats all telephony data that it receives from the telephony interface 460 as high priority data. In an alternative embodiment, the processing engine 410 treats a packet as a high priority packet if the packet indicates that it contains audio data (e.g., through the Type of Service field in an IP header). Yet in another embodiment, the processing engine 410 assigns priority to the delivery of certain data based on the source of the data. For example, an exemplary embodiment of the processing engine 410 may treat data from a particular phone number (or a particular address) as higher priority data than other phone numbers (or addresses).

Compressison Memory Techniques

All exemplary embodiment of the IAD 400 may utilize a memory compression technique. Specifically, the technique involves compressing (with an option to include security measures, such as, without limitation, password protection) executable instructions that are relevant for operating the IAD 400 (e.g., an operating system kernel and application files) and slowing the compressed instructions in ROM in the memory module 430. Upon power-up of the IAD 400, boot logic in the processing engine 410 expands the compressed instructions into a large code block in RAM in the mewory modules 430 (or alternatively, in RAM in the processing engine 410). The aforementioned application files could include, for example and without limitation, software files implementing PnP functionality to probe the universal WAN interface 450 or telephony interface 460, software drivers to recognize and communicate with the universal WAN interface 450 or telephony interface 460, and software files used to store and utilize other system configuration parameters (e.g, LAN configuraton). Such a memory compression technique economizes on non-volatile storage space, prevents the corruption of program data during power outages or abrupt system shutdowns, and prevents security leakages. Those skilled in the art will recognize that the foregoing is merely one example of structuring the memory compression technique of the IAD 400. For example and without limitation, certain application software, such as software for PnP functionality could also be loaded directly into the telephony interface 460, enabling the interface to function independently from the processing engine 410.

Non-Blocking Architecture

In one embodiment of the IAD 400, the processing engine 410 utilizes a non-blocking architecture. Such a non-blocking architecture achieves a significart improvement in voice qality and overall performance. For example and without limitation, the non-blocking architecture may be achieved through a data packet buffering mechanism that stores and forwards data packets while minimizing any noticeable break in speech when the data packets are ultimately converted into audio signals, even when there is poor network transmission due to buffer jitter, network burstiness, network congestion, or lack of bandwidth. An exemplary embodiment of this data packet buffering mechanism involves the processing engine 410 and the memory module 430 of the IAD 400. Specifically, the memory module 430 includes banks of circular buffers that are dedicated to the network I/O ports of the IAD 400. The size of the buffers relates to the maximum determinable delay of the networks. As an illustration, suppose a circular buffer 1 in memory module 430 is dedicated to the input data from a LAN X that is attached to LAN interface 440. The size of the circular buffer 1 would then be:

Size_{circular buffer 1}=maximum determinable delay of LAN X*number of packets/second*number of bytes/packet

The processing engine 410 is capable of tracking and identifying positions of data in these circular buffers. Using the circular buffer 1 as an illustration, one embodiment of the processing engine 410 maintains a position identifier, which points to a memory location that is available for data storage. As new data arrive and are placed in the circular buffer 1 the processing engine 410 increments the position identifier to point to the next available memory location for storage. When the position identifier reaches the end of the circular buffer 1, the processing engine 410 modifies the identifier to “wrap around” and point to the beginning of the circular buffer 1.

In an exemplary embodiment of the aforementioned non-blocking architecture, one bank of the circular buffers is dedicated to store inbound data, and another bank of the circular buffers is dedicated to store outbound data. Alternatively, one bank of circular buffers is resportsible for both the inbound and the outbound data via the network I/O ports. Such an inmplementation of read-write circular buffers may involve multiple position identifiers, where one tracks the inbound data in the buffers, and the other tracks the outbound data.

Those skilled in the art will recognize that the foregoing description of the non-blocking architecture of the IAD 400 is merely an example, and that such non-blocking architectures may be implemented through a variety of software, hardware, or software/hardware combination techniques known in the art.

Universal WAN Interface

In one embodiment of the IAD 400, the universal WAN interface 450 comprises at least one expansion slot. One type of an expansion slot is a Peripheral Component Interconnect (PCI) slot. Another type is a Personal Computer Memory Card International Association (PCMCIA) slot. Using the PCI slot as an illustration, the PCI slot allows the insertion of any expansion boards that are designed to operate with PCI. These expansion boards may include broadband access technologies such as, without limitation, DSL modem technologies, cable modem technologies, wireless modem technologies, T1 technologies, and dial-up modems technologies. Furthennore, the embodiment may also support PnP so that such PCI cards are automatically recognized and configured to work within the device. Those skilled in the art will recognize that the PCI slot is merely used for illustration and that other types of expansion slots or bus architectures including, without limitation, Extended Industry Standard Architecture (EISA) or Vesa Local Bus (Vesa Local Bus) technologies may also be used in the universal WAN interface 450.

Continuing to use the PCI slot as an example, to support PnP functionality, one embodiment of the processing engine 410 probes the PCI slot to determine 1) whether a PCI card has been inserted; and 2) if a PCI card has been inserted, what type of a PCI card is it. To communicate with the PCI card, the processing engine 410 dynamically loads a software driver from secondary memory (part of the memory modules 430) into RAM (part of the memory modules 430, or part of the processing engine 410) that corresponds to the type of the PCI card (e.g., a PCI wireless modem card). If a PCI card is removed, the processing engine 410 releases any resources that it may have committed to support the PCI card. The processing engine 410 may probe the PCI slot during the boot-up or power-up process or dynamically, whenever a PCI card is inserted or removed from the universal WAN interface. Those skilled in the art will recognize that such PnP functionality may be implemented through a variety of software, hardware, or software/hardware combination techniques known in the art.

Telephony Interface

One embodiment of the telephony interface 460 includes, for example and without limitation, a processing logic core, which may be a DSP, or a Field Programmble Gate Array (FPGA), a COder/DEC (CODEC) circuitry that includes both an analog-to-digital converter (ADC) and a digital-to-analog converter (DAC), voice-coder (vocoder) circuitry, and Subscriber Line Interface Circuit (SLIC) circuitry. These circuitries mentioned above enable the telephony interface 460 to accommodate telephony features and functionalities including, without limitation, ADC and DAC functionality, tone detection and generation, and speech encoding and decoding algorithms such as, but not limited to, G.723.1, G.729, G.726, A-law, and u-law. Furthermore, such circuitries also allow the processing engine 410 to receive data packets from the networks, either through the universal WAN interface 450 via network I/O 480 or LAN interface 440 via network I/O 470, relay the data packets to the telephony interface 460 for digital-to-analog conversion and transmission of the converted analog signals to the telephony network. In the opposite process, the telephony interface 460 packetizes the analog signals that it receives and relays the data packets to either the LAN interface 440 or the WAN interface 450 for packet transmission. For example and without limitation, the supported protocols for such conversion processes may include such VoIP standards as H.232, SIP and MGCP.

Those skilled in the art will recognize that the foregoing is merely one example of possible circuitries and functionalities that may be provided in the telephony interface 460 and that there are numerous ways to provide and implement these as well as additional features and fuctionalities, including without limitation, pure hardware (circuitry) solutions, software solutions that may, for example and without limitation, interact with a DSP in the processing engine 420 and software stored in the memory modules 430, as well as hybrid software and hardware solutions.

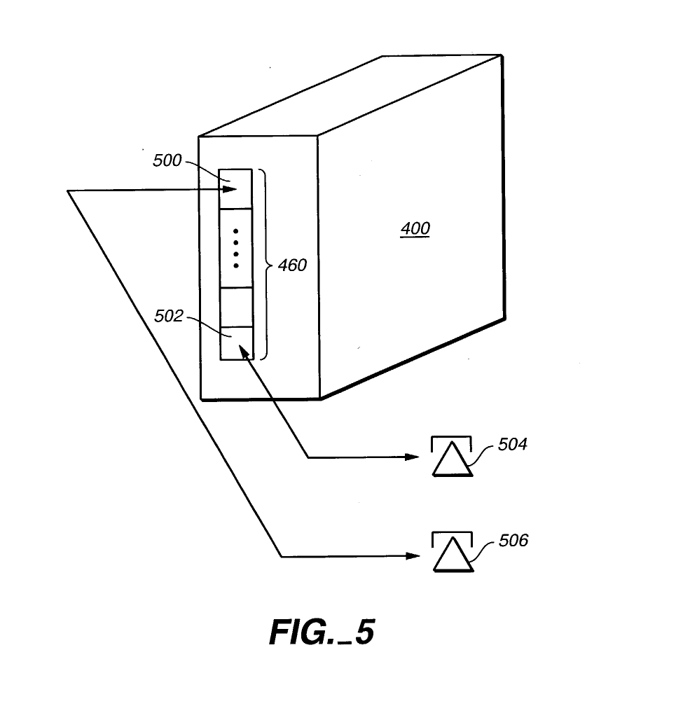

As shown in FIG. 5, the telephony interface 460 of the IAD 400 can accommodate multiple voice port modules, such as voice ports 500 and 502. In an exemplary embodiment, the IAD 400 supports a variety of different voice port modules. Specifically, the telephony interface 460 may include a set of FXS voice ports, a set of FXO voice ports, or a combination set of FXS and FXO ports. As an illustration, one embodiment of the telephony interface 460 included a number of Registered Jack-11 (RJ11) connectors and a number of corresponding FXS port modules. For FXS ports, the connections involves two (i.e., the red and green pair) of the six wires between the IAD 400 and telephones 504 and 506. In an alternatively embodiments, the telephony interface 460 supports a number of RJ-11 connectors and a number of corresponding FXO port modules. The connections also involve two (i.e., the yellow and black pair) of the six wires. In yet another embodiment, the telephony interface 460 supports a plurality of voice ports, where each port is separately configurable as either an FXS or FXO port. Furthermore, another embodiment of the IAD 400, the telephony interface 460 may include a combination of non-configurable and configurable voice port modules. Such modules may be stacked or plugged into the IAD 400 to increase the number of voice ports that are supported by the IAD. Thus, if the telephony interface 460 supports five voice port modules, and each module has four voice ports, the telephony interface 460 would then support a total of twenty voice ports.

An exemplary embodiment of the telephony interface 460 also supports Pnp functionality. For example and without limitation, in order to support PnP functionality, one embodiment of the processing engine 410 as shown in FIG. 4 probes the telephony interface 460 to determine the number and type of voice port modules that have been inserted. Then the processing engine 410 dynamically loads the corresponding drivers from a firmware module (part of the memory modules 430) into a FPGA in the telephony interface 460 so that a DSP in the telephony interface 460 can communicate with the voice port modules. Such probing of the telephony interface may be activated during the boot-up or power-up process or dynamically, whenever a telephony module is inserted or removed from the telephony interface. However, those skilled in the art will recognize that such PnP functionality may be implemented through a variety of software, hardware, or sofrware/hardware combination techniques known in the art. Once the loading of the appropriate drivers is completed, the telephony interface 460 may operate as a separate module responding to interrupt messages from the telephony network communications and/or socket messages from data network comnmunications.

Configuration Utilities

The IAD 400 further includes capabilities to process requests from a user to configure parameters in the IAD. In one embodiment of the IAD 400, these user-configurable parameters are stored in memory module 430. Some examples of the user-configurable parameters are, without limitation, parameters that pertain to the universal WAN interface 450 or LAN interface 440, parameters that are indicative of static IP and DHCP options, parameters that configure a default gateway, or parameters that set netmasks.

The user may configure the IAD through the peripheral device 420 (e.g., a terminal display and a telnet interface). Alternatively, such a terminal display may communicate with the IAD 400 through the LAN 440 or universal WAN interface 450. Yet another embodiment of the configuration utilities may utilize a web browser to configure the IAD 400. Similarly, such a web browser may be directly connected to the IAD (i.e., as peripheral device 420) or may communicated with the IAD 400 through the LAN 440 or universal WAN 450, Those skilled in the art will recognize that there are numerous methods of communicating with the IAD 400 for parameter configuration.

Environments for the Present Invention

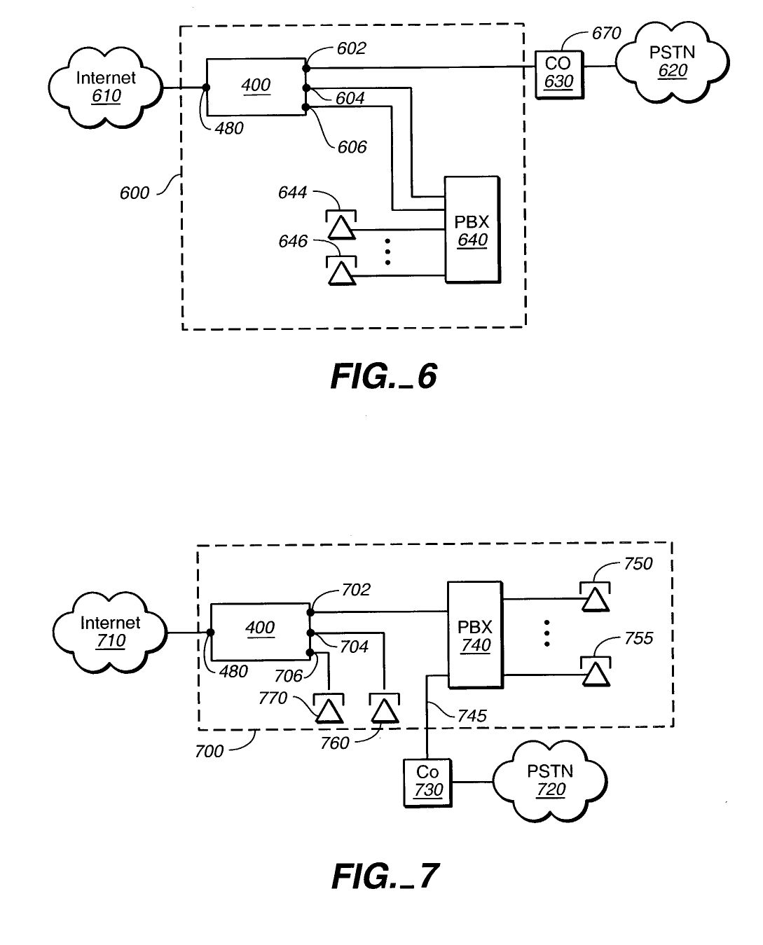

FIG. 6 and FIG. 7 illustrate exemplary network architectures within a business that the IAD 400 operates in. For example, in FIG. 9, the IAD 400 serves as the access point of business 600 to both the lnternet 610 and the PSTN 620. As illustrated, the network I/O port 480 along with the associated universal WAN interface 450 (the interface is not shown in FIG. 6) of the IAD 400 provides an access to the Internet 610. The ports 602, 604, and 606 collectively correspond to network I/O port 490 as shown in FIG. 4. In FIG. 6, the port 602 is an FXO port, which couples the IAD 400 to the Central Office 630 of the local telephone service provider which ultimately provides access to the PSTN 620. The ports 604 and 606 are FXS ports and are coupled to the PBX 640 of the business 600. The analog phones (e.g., 644 and 646) that are used in the business 600 are coupled to the PBX 640.

In FIG. 7, the IAD 400 only serves as the access point of a business 700 to the Internet 710. As illustrated, the network I/O port 480 along with the universal WAN interface 450 (the interface is not shown in FIG. 7) of the IAD 400 provides an access to the Internet 710. Similarly, the ports 702, 704, and 706 collectively correspond to the network I/O port 490 as shown in FIG. 4. The ports 704 and 706 are both FXS ports and are coupled to analog phones, 760 and 770, respectively. The port 702 is also an FXS port and is coupled to the trunk side of the PBX 740 of the business 700. A T1 line 745 couples the trunk side of the PBX 740 to a Central Office 730 of the local telephone service provider which ultimately provides access to the PSTN 720 The extension side of the PBX 740 also couples two other analog phones, 750 and 755 used within the business 700.

As has been demonstrated, the IAD 400 represents a significart improvement over prior IADs, because its scalability and flexibility enable it to satisfy the growing needs of a business. In particular, the IAD 400 converges telephony and data services over the same network thereby economizing costs for the business [i.e., the reduction of data and telephony installation and start-up charges and the dynamic management (e.g., immediate and costless activation or deactivation) of additional internal phone lines]. Moreover, because the IAD 400 could easily upgrade its capabilities (e.g., network and routing services) using the aforementioned PnP method, a business with the IAD 400 is able to enjoy the additional services that its networks support without having to acquire additional equipment. Some example of the services include, without limitation, proxy services, a firewall, DHCP server/client services, and static IP services. Those skilled in the art will recognize that in addition to the foregoing, there are numerous other services that may be incorporated into the IAD 400.

In addition, the IAD 400 provides the ability to easily expand telephony capacities and accommodate various broadband access technologies. As detailed in the Background section above, with prior IADs, once their capacity to support additional phones has been met, a business must purchase additional IADs (or other telephony equipment) to provide further capacity. Similarly, if a business chooses to expand or change its broadband access technology, it must purchase additional or even different IADs in order to support the expansion or change since the prior IADs only provide a single, umchangeable broadband option (e.g., either T1, DSL, cable or dial-up). In contrast, the IAD 400 can easily expand its telephony capacity as well as expand or change broadband options without purchasing additional devices. As such, having the IAD 400 eliminates the need for a business to train its employees on different IADs and again minimizes the costs of modifying the networks of the business.

Moreover, the IAD 400 allows a business to deploy the VoIP technologies discussed in the Background section above. The IAD 400 can again use the PnP method to include standards-compliart technologies for compatibility and interoperability with other network devices. For example and without limitaton, the IAD 400 may support VoIP protocols such as H.323, SIP, and MGCP as well as other proprietary protocols. Those skilled in the art will recognize that VoIP is only one illustration of telephony over packet-switched data networks and that the IAD 400 may also support other types of packet-switched network telephone technologies, including but not limited to Voice over DSL (VoDSL), Voice over ATM (VoATM) and Voice over Frame Relay (VoFR).

The various embodiments described in the above specification should be considered as merely illustrative of the present invention. They are not intended to be exhausive or to limit the invention to the forms disclosed. Those skilled in the art will readily appreciate that still other variations and modifications may be practiced without departing from the general spirit of the invention set forth herein. Therefore, it is intended that the present invention be defined by the claims that follow.

I claim:

1. An integrated access device for integrating data and telephony services, comprising:
a processing engine;
a memory module, coupled to the processing engine;
a data network interface, coupled to the processing engine, wherein
the processing engine dynamically reconfigures the data network interface to support a variety of broadband access technologies based on changing user requirements; and
a telephony interface, coupled to the processing engine, comprising at least one telephony module, wherein
the telephony module further comprises a variety of voice ports.

2 The integrated access device of claim 1, wherein the data network interface further comprises:
aplurality of expansion slots to-receive expansion-boards-that support the variety of broadband access technologies.

3. The integrated access device of claim 2, wherein the processing engine detects the attachment of the expansion boards to the expansion slots and determines the types of the broadband access technologies that the expansion boards support.

4 The integrated access device of claim 3, wherein the processing engine, the data network interface, and the telephony module support plug-and-play operations5

5. The integrated access device of claim 1, wherein the processing engine allocates resources in resportse to a service request. converts the resources, and releases the resources after having completed the service request.

6. The integrated access device of claim 1, wherein the data network interface is a WAN interface.

7. The integrated access device of claim 1, wherein the processing engine detects the attachment of the telephony module To the telephony interface.

8. The integrated access device of claim 1, wherein the processing engine dynamically rcconfigurcs the tlephony modlul to support the variety of tle voice ports.

9. The integrated access device of claim 8, wherein each of the variety of the voice ports is configurable either as an Foreign Exchange Office or Foreign Exchange Station port

10. The integrated access device of claim 1, wherein the memory module contains compressed executable instructions.

11. The integrated access device of claim 1, wherein the processing engine uses 20 circular buffers in the nmemory module to manage data flow iin and out of the integrated access device.

12. The integrated access device of claim 1, wherein the processing engine modifies a user-defined parameters that is stored in the memory module in resportse to a user 25 request.

13. A method of integrating data and telephony services in a device, comprising:
dynamically contiguing network input and output ports of the device to support connectivity To a varying number of data networks, a varing number of public switched telephone networks, arid a varying number of commuijcation devices;
dynamically adopting broadband access technologies for the device to access the data networks based on changmg user requirements; and
maintaining data interoperability among the data nerwovls, the public switched telephone networks, and the communication devices.

14. The method of claim 13. futher comprises:
detecting the attachment of an expansion cad to an cxpansiun slot of the device; and
configuring the device to support the broadband access technology of the expansion card.

15. The method of claim 13, fiber comprises:
detecting the attachment of a telephony module to a telephony interface of the device; and
..configung the telephony moduleio supporta variety ofvoice ports

16. The method of claim 15, Sfuther comprises:
config g each of the variety of the voice ports either as an Foreign Exchange Office or Foreign Exchange Station ponr

17. The method of claim 13, fixvher comprises:
allocating resources in isesportse to a service request;
converting the resources to maintain the data interoperability; and
releasing the resources atter having completed the service request.

18. The method of claim 13, firther comprises:
retrieving compressed executable instructions from a memory module of the device for the device to perform its functions

19. The method of clam 13,ifurthercoMprscs:
managing data flow in and out 6f tihe device with circular buffers in the memory module.

20. The method of claim 13, furier comprises:
setting a user-defined parameters of the device in resportse To a user request.

21. A computer readable medium containing executable instructions for integraling data and telephony services in a device, which when executed cause the device to:
dynamically coafige netwoik input and output ports of the device to support connectivity to a varying number of data networks, a varying number of public switched telephone networks, and a varying number of communication device;
dynamically adopt broadband access technologies for the device to access the data networks based on changing user requirements; and
maintain data interoperability among the data networks, the public switched telephone networks, and the communication devices.

22. The computer readable medium of claim 21, wherein the execution of the executable instructions fisher causes the device to:
detect the attachment of an expansion card to an expansion slot of the device, and
support the broadband access technology of the expansion card.

23. The computer readable medium of claim 21, wherein The execution of the executable instructions flrther causes the device to:
detect the attachment of a telephony module to a telephony interface of the device; and
configure the telephony module to support a variety of voice ports24.

24. The computer readable medium of claim 23, wherein the execution of the executable instructions further causes the device to:
configure uach of the: varict of Lhc voice ports cither au Foreign Exchange Office or Foreign Exchange Station port.

25. The computer readable medium of claim 21, wherein the execution of The executable instructions further causes the device to:
allocate resources in resportse to a service request;
convert The resources to maintain the data interoperability, and release the resources after having completed The service, request

26. The computer readable medium of claim 21, wherein the executable instructions are compressed.

27. The computer readasble medium of claim 21, wherein the execution of the executable instructions further causes the device to:
manage data flow in and out of the device with circular buffersin the memory nodule.

28. The computer readable medium of claim 21, wherein the execution of the executable instructions frther causes the device To:
set a user-defined parrreters of the device in repnse to a user request,!
